(19) United States
(12) Patent Application Publication
(10) Pub. No.: US 2007/0273533 A1
(43) Pub. Date: Nov. 29, 2007

(54) Method for inserting radio frequency identification tag into an optical disc

(76) Inventors: Cheng-Lu Yang, Taipei (TW); Kuoens Wu, Taipei (TW)

Correspondence Address: TROXELL LAW OFFICE PLLC, SUITE 1404, 5205 LEESBURG PIKE, FALLS CHURCH, VA, 22041, US

(21) Appl. No.: 11/440,468

(22) Filed: May 25, 2006

(51) Int. Cl. G08B 13/14

(52) U.S. Cl. 340/572.8

(57) ABSTRACT

A method discloses for inserting a radio frequency identification tag into an optical disc firstly providing a set of base plates and a radio frequency identification tag. A recess is provided on the peripheries of the base plates, and adhesive is spread there between the set of base plates in order to combine the bases plates and fix the radio frequency identification tag therein the recess of the peripheries of the base plates.

### BACKGROUND OF THE INVENTION

1. Field of the Invention

The present invention relates to a method for inserting a radio frequency identification (RFID) tag into an optical disc and in particular to a method by providing a set of base plates and a radio frequency identification tag. A recess is provided at the peripheries of the base plates for inserting the radio frequency identification tag therein.

2. Description of the Prior Art

Radio frequency identification tags can be used for a variety of purposes such as stock management, automatic identification system for vehicles at toll station, security system and electronic access control etc. And if compared with those widely used bar codes, the radio frequency identification tags can be read in a bad working environment, such as in snow, fog and so like, and further they have the advantages of counterfeit proofing, longer reading ranges, more data storing capability and easy access to internal data amendment etc. Thereby, the radio frequency identification tags are expected to replace the barcodes gradually.

At present, the technique of using radio frequency identification tags onto an optical disc is to have a radio frequency identification tag onto a surface of the central region of the optical disc. When in use, a single optical disc manufactured in accordance with the present technique surely can achieve the objects of counterfeit proofing, data reading and data amending. However, in a situation when a plurality of optical discs are piled, usually only the radio frequency identification tag on the uppermost optical disc can be read effectively; while the others there between in the piled optical discs may not be able to be read so that the objects of counterfeit proofing and data changes in each of radio frequency identification tag of each optical disc can not be achieved.

In view of the disadvantages in use of the abovementioned conventional technique, the applicant had previously filed an application for a structure having a radio frequency identification tag inserted into the periphery of an optical disc. And after further studying and improvement, the present invention is further provided a method for manufacturing said structure effectively. And the method in accordance with the present invention not only can securely insert the radio frequency identification tag into the periphery of an optical disc, but also can achieve the objects of counterfeit proofing, data reading and data amending of the inserted radio frequency identification tag.

### SUMMARY OF THE INVENTION

The primary objective of the present invention is to provide a method of inserting a radio frequency identification tag into an optical disc. By providing a set of base plates having a recess on their peripheries for inserting and fixing the radio frequency identification tag therein, so that when a plurality of optical discs are piled, radio signals of each optical disc can still be transmitted, received and read effectively.

The secondary objective of the present invention is to provide a method of inserting a radio frequency identification tag into an optical disc. By filling adhesive between the set of base plates and afterwards by rotating the set of base plates to uniformly spread the adhesive from inside out, further by using a two stages curing method to make the radio frequency identification tag easily placed in the recess, and securely fixed therein.

In order to achieve the above objects, a method of inserting a radio frequency identification tag into an optical disc with accordance to the present invention is first by providing a set of base plates and a radio frequency identification tag. With a recess provided at the peripheries of the base plates, the radio frequency identification tag can be inserted therein and fixed securely.

The above method further comprises a step, i.e. before combing the set of base plates, adhesive fills the central region between the set of base plates. The adhesive itself can be cured after an irradiation of ray. And afterwards by rotating the set of base plates to spread the adhesive uniformly from inside out to make the inserted radio frequency identification tag in the recess of the peripheries of the base plates being cohered with the base plates and further by an irradiation of ray to cure the adhesive there between to make the inserted radio frequency identification tag securely fix with the base plates.

In practical use, by providing a partition board in advance to prevent irradiation of ray into the recess on the peripheries of the base plates, and so the adhesive there between the set of base plates can be cured firstly to combine each other. Afterwards, by cohering the radio frequency identification tag into the recess of the peripheries of the set of base plates and fixing it securely therein by irradiation of ray.

Further, in the above step, a groove can also be provided inside of the peripheries of the set of base plates to receive the adhesive spreading outwards during rotation of the set of base plates. And the radio frequency identification tag is firstly applied with an adhesive, and then inserted in the recess of the peripheries of the set of base plates; this can also fix the radio frequency identification tag securely.

The present invention will be apparent after reading the detailed description of the preferred embodiment thereof in reference to the accompanying drawings.

### BRIEF DESCRIPTION OF THE DRAWINGS

FIG. 1 is a perspective view showing the appearance of the optical disc made by the present invention;

FIG. 2 is a sectional view showing the combination of the optical disc made by the present invention;

FIG. 3 is a flow chart of the manufacturing method process of a first embodiment of the present invention;

FIG. 4 is a schematic sectional view showing steps a and b for the first embodiment of the present invention;

FIG. 5 is a schematic sectional view showing steps c and d for the first embodiment of the present invention;

FIG. 6 is a schematic sectional view of the first embodiment of the present invention showing that a recess is provided on the upper surface of the lower base plate;

FIG. 7 is a flow chart of the manufacturing method process of a second embodiment of the present invention;

FIG. 8 is a schematic sectional view showing a step C for the second embodiment of the present invention; and

FIG. 9 is a schematic sectional view of a third embodiment of the present invention before cohering the set of base plates with a radio frequency identification tag.

### DETAILED DESCRIPTION OF THE PREFERRED EMBODIMENTS

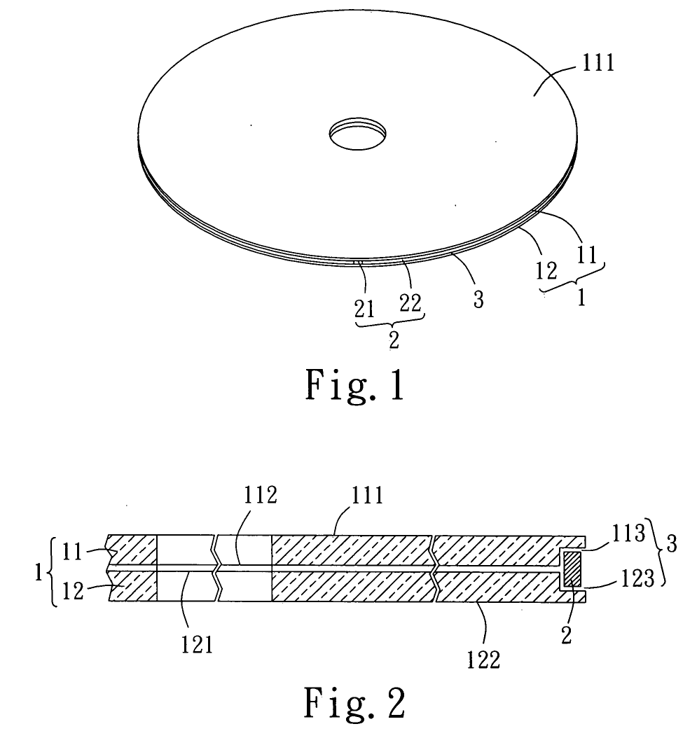

Referring to FIGS. 1 and 2, which show a method of the present invention for inserting a radio frequency identification tag into an optical disc. Firstly a set of base plates 1 and a radio frequency identification tag 2 are provided, and a recess 3 is further provided in the peripheries of the set of base plates 1 in order to insert the radio frequency identification tag 2 therein.

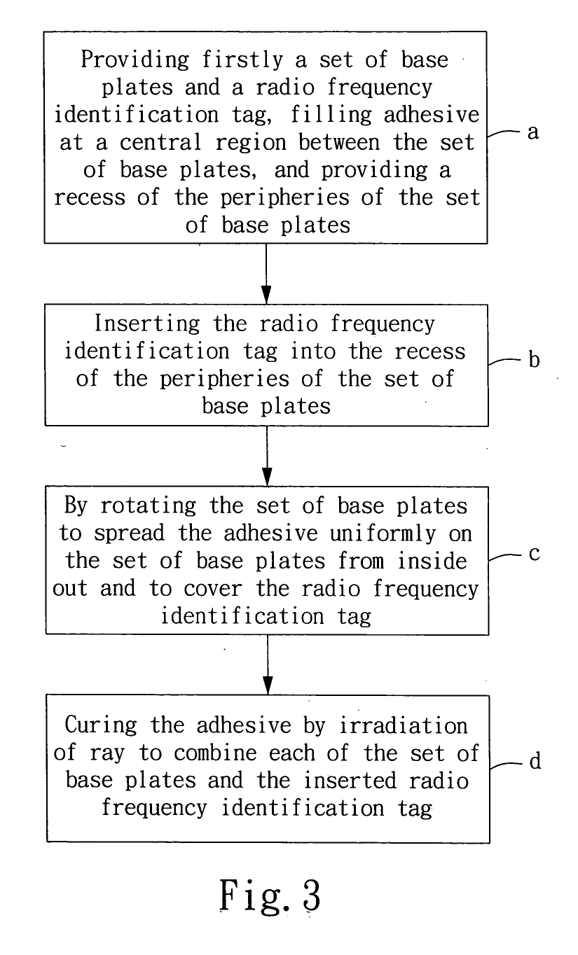

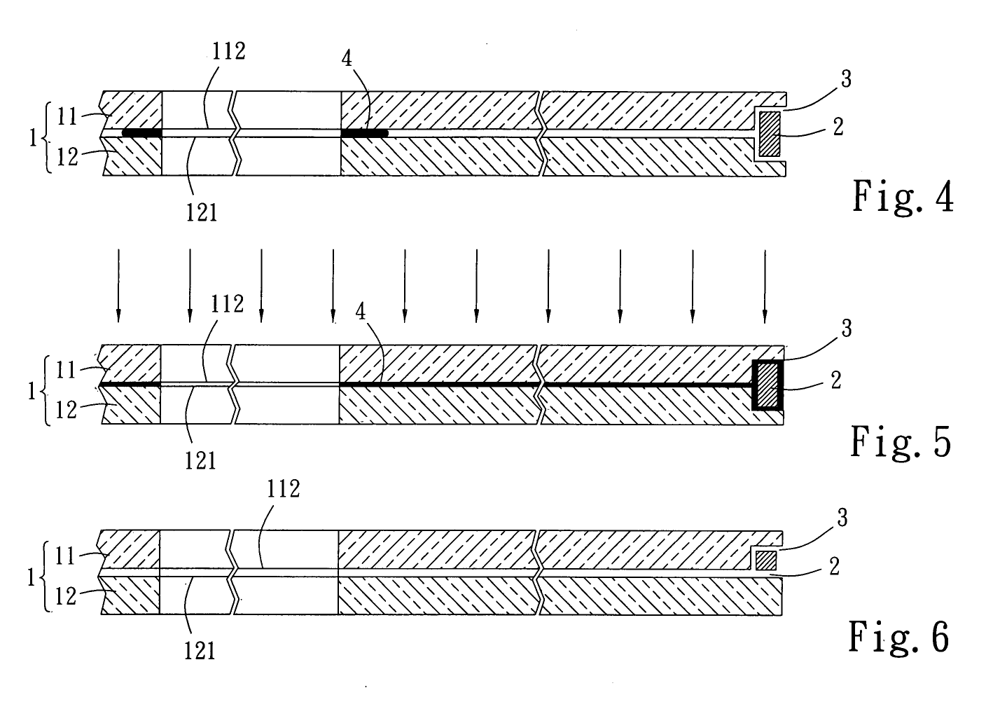

As shown in FIGS. 1 and 3-5, which show the first embodiment of the present invention, the method process includes the following steps:
a. providing firstly a set of base plates and a radio frequency identification tag, filling adhesive at a central region between the set of base plates, and providing a recess of the peripheries of the set of base plates;
b. inserting the radio frequency identification tag into the recess of the peripheries of the set of base plates;
c. by rotating the set of base plates to spread the adhesive uniformly on the set of base plates from inside out and to cover the radio frequency identification tag; and
d. curing the adhesive by irradiation of ray to combine each of the set of base plates and the inserted radio frequency identification tag.

In the step a, the used adhesive 4 has a curing feature after being irradiated by ray and the chosen ray is ultraviolet ray or any kind of light beams able to have the effect of curing after being irradiated. The radio frequency identification tag 2 comprises a chip 21 and an antenna 22 extending outwards from of the two lateral sides of the chip 21. The set of base plates 1 comprise an upper base plate 11 and a lower base plate 12; and the upper and lower base plate 11 and 12 comprise respectively upper and lower surfaces 111, 112, 121 and 122. A notch 113 and 123 are respectively provided of the periphery of the lower surface 112 of the upper base plate 11 and the periphery of the upper surface 121 of the lower base plate 12. The two notches 113 and 123 together form the recess 3. The recess 3 can also be provided solely on the periphery of the lower surface 112 of the upper base plate 11 (as shown in FIG. 6) or on the periphery of the upper surface 121 of the lower base plate 12. The shape of the recess 3 is not limited to the rectangular shape depicted in the accompanying drawings, it can also be arc-form, a V shape or any other shapes able to cover or receive the shape of the radio frequency identification tag 2.

In the step b, when the radio frequency identification tag 2 is inserted into the recess 3 of the peripheries of the set of base plates 1, the antenna 22 at the two lateral sides of the chip 21 separately arcs along the peripheries of the set of base plates 1. The preferred length of the antenna 22 and the chip 21 together is a half of the peripheries of the set of base plates 1, in order to transmit, receive and read radio frequency signals in various directions.

In the step c, before combing the upper base plate 11 and lower base plate 12 to form the set of base plates 1, adhesive 4 is filled there between. Further, the set of base plates 1 are fixed on a rotate-able disk (not shown), so that when the set of base plates 1 rotate around each own axis, the adhesive 4 will be spread uniformly from inside out there between the upper base plate 11 and the lower base plate 12. In the rotation process, the upper base plate 11 presses down the lower base plate 12 by its own weight; this can increase the combining force there between the upper base plate 11 and the lower base plate 12. And in practical use, additional pressure can further put on the upper base plate 11 to make even tighter combination of the upper base plate 11 with the lower base plate 12.

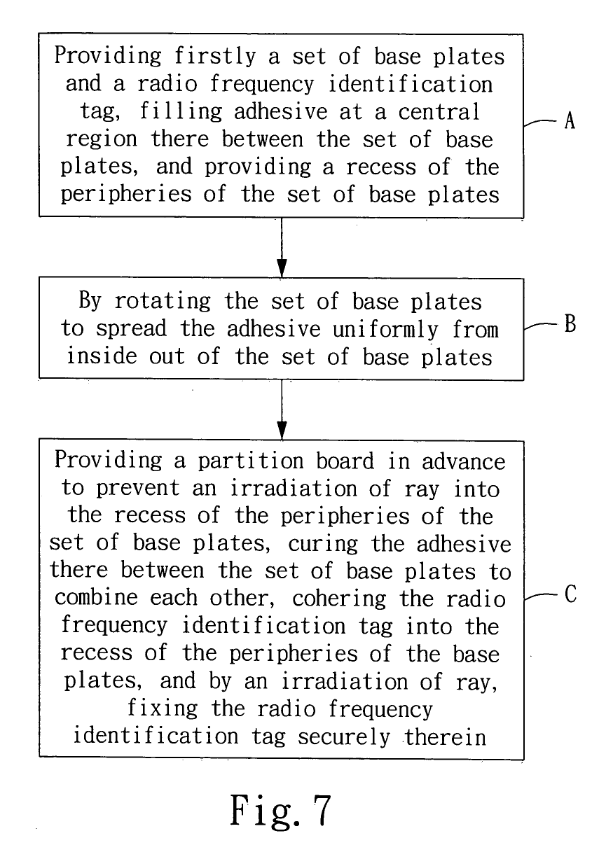

Referring to FIG. 7, which is a flow chart of the method process of a second embodiment of the present invention, it comprises the following steps:
A. providing firstly a set of base plates and a radio frequency identification tag, filling adhesive at a central region there between the set of base plates, and providing a recess of the peripheries of the set of base plates;
B. by rotating the set of base plates to spread the adhesive uniformly from inside out of the set of base plates; and
C. providing a partition board in advance to prevent an irradiation of ray into the recess of the peripheries of the set of base plates, curing the adhesive there between the set of base plates to combine each other, cohering the radio frequency identification tag into the recess of the peripheries of the base plates, and by an irradiation of ray, fixing the radio frequency identification tag securely therein.

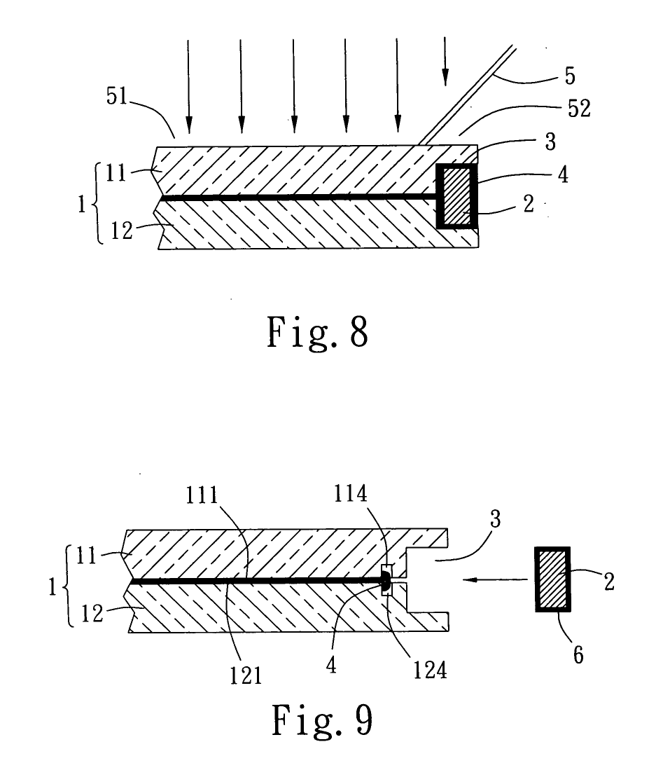

As shown in FIG. 8, in the above step C, by the partition board 5, the set of base plates 1 form a light receiving surface 51 and a light un-receiving surface 52. The light un-receiving surface 52 is defined at the region above the recess 3 of the peripheries of the set of base plates 1. When the light receiving surface 51 is irradiated with a ray, the adhesive 4 there between the upper and the lower base plates 11, 12 is cured, while the adhesive 4 in the recess 3 is still in adhesively condition for allowing an insertion of the radio frequency identification tag 2. And after a second time irradiation, the adhesive 4 in the recess 3 is cured to securely fix the radio frequency identification tag 2 therein.

Referring to FIG. 9, which shows a third embodiment of the present invention, wherein the lower surface 112 of the upper base plate 11 and the upper surface 121 of the lower base plate 12 are provided inside each of them with a notch 114, 124 to receive the adhesive 4 spreading outwards during rotation of the set of base plates 1. The radio frequency identification tag 2 is spread on its surface with adhesive 6. When the radio frequency identification tag 2 is inserted into the recess 3 of the peripheries of the set of base plates 1, the radio frequency identification tag 2 can be cohered with the set of base plates 1.

In the above steps, the notches 114 and 124 can also be solely provided on either the lower surface 112 of the upper base plate 11 or the upper surface 121 of the lower base plate 12. This can also achieve the object of preventing the adhesive 4 from spreading outwards. The adhesive 6 can be filled in the recess 3 of the peripheries of the set of base plates 1 in advance and then the radio frequency identification tag 2 is inserted therein for cohesion. Further, the nature of the adhesive 6 can be same as that of the adhesive 4, i.e. when being irradiated of ray, the adhesive 6 is cured to securely fix the radio frequency identification tag 2.

Therefore, the present invention has the following advantages:
1. The present invention discloses a method for inserting a radio frequency identification tag into the peripheries of the set of base plates. This not only can effectively overcome the communication problem for a piled of optical discs, but also can make the radio frequency signals to be effectively received and read.
2. The present invention discloses a method which by rotating the set of the base plates to spread the adhesive uniformly on the set of base plates from inside out and to cover the radio frequency identification tag; further after curing of the adhesive, the radio frequency identification tag can be securely fixed in the recess. This can effectively reduce the time for spreading the adhesive to thus save cost accordingly.
3. The present invention has a two stages way of curing the adhesive. This not only can help the radio frequency identification tag to be inserted into the recess of the set of base plates easily, but also can securely fix the radio frequency identification tag into the recess of the peripheries of the set of base plates to increase the cohesion there between the radio frequency identification tag and the set of the base plates.

In conclusion, according to the description disclosed above, the present invention surely can achieve the expected objects thereof to provide a method of not only securely insert a radio frequency identification tag into a recess of the periphery of a optical disc, but also can surely achieve the objects of counterfeit proofing, data reading and data amending etc. in the radio frequency identification tag. Thereby the present invention is industrially useful.

Having thus described the present invention with novelty and improvement, what I claim as new and desire to be secured by Letters Patent of the United States is:

1. A method for inserting a radio frequency identification tag into an optical disc by proving firstly a set of base plates and a radio frequency identification tag, wherein a recess is provided on peripheries of said set of base plates for inserting said radio frequency identification tag therein.

2. The method for inserting a radio frequency identification tag into an optical disc as claimed in claim 1, wherein said method further comprises a step: before combing said set of base plates, adhesive is filled in advance there between said set of base plates, and said adhesive is cured after irradiation of ray.

3. The method for inserting a radio frequency identification tag into an optical disc as claimed in claim 2, wherein said ray is ultraviolet ray.

4. The method for inserting a radio frequency identification tag into an optical disc as claimed in claim 2, wherein said adhesive is filled at a central region there between said set of base plates and said set of base plates are fixed on a rotate-able disk, so that by a rotation of said set of base plates about their own axis, said adhesive is spread uniformly from inside out.

5. The method for inserting a radio frequency identification tag into an optical disc as claimed in claim 4, wherein said radio frequency identification tag is inserted firstly in said recess of said peripheries of said base plates, and is securely fixed therein with the out-spread adhesive caused by a rotation of said set of base plates.

6. The method for inserting a radio frequency identification tag into an optical disc as claimed in claim 5, wherein said method further comprises a step: said adhesive filled there between said base plates is cured after irradiation of ray to combine said base plates and to securely fix said radio frequency identification tag.

7. The method for inserting a radio frequency identification tag into an optical disc as claimed in claim 4, wherein said set of base plates are combined firstly, then said radio frequency identification tag is cohered therein said recess of said peripheries of said set of base plates.

8. The method for inserting a radio frequency identification tag into an optical disc as claimed in claim 7, wherein said method further comprises a step: proving a partition board to prevent irradiation of ray onto said recess of said peripheries of said base plates, thus said adhesive there between said set of base plates is cured for combining said base plates, and then said radio frequency identification tag is inserted and cohered therein said recess of said peripheries of said base plates by irradiation of ray.

9. The method for inserting a radio frequency identification tag into an optical disc as claimed in claim 4, wherein said method further comprises a step: said set of base plates are provided inside each with a notch to receive said out-spread adhesive during rotation of said set of base plates; said radio frequency identification tag is applied thereon with adhesive, in order that said radio frequency identification tag is cohered and fixed therein said recess of said peripheries of said set of base plates.

10. The method for inserting a radio frequency identification tag into an optical disc as claimed in claim 4, wherein said method further comprises a step: a pressure is put on said set of base plates to make an even tighter combination.
